(19) United States
(12) Patent Application Publication
(10) Pub. No.: US 2015/0047560 A1
(43) Pub. Date: Feb. 19, 2015

(54) MASK FOR DEPOSITING AN ORGANIC LAYER AND MASK ASSEMBLY FOR THE SAME

(71) Applicant: SAMSUNG DISPLAY CO., LTD., YONGIN-CITY (KR)

(72) Inventor: TAEK-KYO KANG, YONGIN-CITY (KR)

(73) Assignee: SAMSUNG DISPLAY CO., LTD., YONGIN-CITY (KR)

(21) Appl. No.: 14/269,961

(22) Filed: May 5, 2014

(30) Foreign Application Priority Data
Aug. 14, 2013 (KR) 10-2013-0096831

(51) Int. Cl. B05C 21/00

(52) U.S. Cl. CPC B05C 21/005
USPC 118/504

(57) ABSTRACT

A mask having two end terminals supported by a frame is provided. The mask includes a mask main body, a plurality of active patterns, and a plurality of first dummy patterns. The mask main body has a band shape extended in the first direction. The plurality of active patterns is separately disposed in the first direction on the mask main body. The plurality of first dummy patterns is disposed between neighboring active patterns from among the plurality of active patterns. Each of plurality of active patterns has a first shape and each of the plurality of first dummy patterns has a second shape.

### CROSS-REFERENCE TO RELATED PATENT APPLICATION

This application claims priority under 35 U.S.C. §119(a) to Korean Patent Application No. 10-2013-0096831, filed on Aug. 14, 2013, in the Korean Intellectual Property Office, the disclosure of which is herein incorporated by reference in its entirety.

### TECHNICAL FIELD

The present invention relates to a mask and a mask assembly, and more particularly, to a mask for depositing an organic layer and a mask assembly for the same.

### DISCUSSION OF THE RELATED ART

A flat panel display may be characterized by an organic light emitting display, a liquid crystal display, or a plasma display panel, etc.

The organic light emitting display may be manufactured by forming an electrode having specific patterns, an organic emission layer, or the like. To form the electrode, the organic emission layer, or the like, a deposition method using a mask assembly may be used.

The organic light emitting display includes a plurality of pixels arrayed in a matrix form. Each pixel is a basic unit displaying images on a substrate and includes an organic light emitting diode that has an anode, a first electrode, a cathode, and a second electrode sequentially formed with organic emission layers. Each of the organic emission layers emits colored light such as red, green, blue, or white colors. Since organic materials forming the organic emission layer may be vulnerable to moisture, oxygen, or the like, they may be isolated from moisture during a process of forming the organic emission layer and after the process of forming the organic emission layer. Therefore, it may be difficult to perform patterning using a general photolithography process. Consequently, the organic emission layer is formed using a mask in which active patterns are formed. Each of the active patterns has an opening through which deposition materials penetrate.

Recently, a mask assembly including a frame with openings and a plurality of masks in a band shape has been used. Each of the plurality of masks may correspond to one of the openings and both ends of each mask are fixed to the frame.

The mask assembly in related arts may be fixed to a frame by applying tensile force to the mask, such that a shape of the active pattern formed in the mask may be deformed due to the tensile force applied to the mask.

### SUMMARY OF THE INVENTION

According to an exemplary embodiment of the present invention, a mask having two end terminals supported by a frame is provided. The mask includes a mask main body, a plurality of active patterns, and a plurality of first dummy patterns. The mask main body has a band shape extended in the first direction. The plurality of active patterns is separately disposed in the first direction on the mask main body. The plurality of first dummy patterns is disposed between neighboring active patterns from among the plurality of active patterns. Each of the plurality of active patterns has a first shape and each of the plurality of first dummy patterns has a second shape.

In an embodiment, the mask may further include a second dummy pattern disposed between an outermost active pattern in the first direction from among the plurality of active patterns and one end terminal of the mask main body. The second dummy pattern may have a third shape.

In an embodiment, the second dummy pattern may include a quadrangular dummy opening.

In an embodiment, the mask may further include a third dummy pattern disposed between the outermost active pattern in the first direction from among the plurality of active patterns and the second dummy pattern. The third dummy pattern may have the second shape.

In an embodiment, each of the plurality of first dummy pattern may include a plurality of first openings and a first rib. The plurality of first opening may be extended in a second direction crossing the first direction and may be disposed to neighbor each other in the first direction. The first rib may surround each of the first openings.

In one embodiment, the mask may further include a fourth dummy pattern disposed between the outermost active pattern in the first direction from among the plurality of active patterns and the second dummy pattern. The fourth dummy pattern may have a fourth shape.

In an embodiment, the fourth dummy pattern may include a plurality of trapezoidal second openings, a plurality of triangular third openings, and a second rib. The plurality of trapezoidal second openings may be alternately disposed in the second direction. The second rib may surround each of the trapezoidal second openings and the triangular third openings.

In an embodiment, each of the first dummy patterns may include a plurality of triangular fourth openings and a third rib. The plurality of triangular fourth openings may be disposed to neighbor each other and may form a quadrangular shape. The third rib may surround each of the triangular fourth openings.

In an embodiment, the mask may further include a fifth dummy pattern. The fifth dummy pattern may be disposed between the outermost active pattern in the first direction from among the active patterns and the second dummy pattern. The fifth dummy pattern may have a fifth shape.

In an embodiment, the fifth dummy pattern may include a plurality of fifth openings and a fourth rib. The plurality of fifth openings may be extended in a second direction crossing the first direction and disposed to neighbor each other in the first direction. The fourth rib may surround each of the fifth openings.

In an embodiment, each of the plurality of first dummy patterns may include a plurality of sixth openings and a fifth rib. The plurality of sixth openings may be disposed in a matrix form in the first direction and a second direction crossing the first direction. The fifth rib may surround each of the sixth openings.

In an embodiment, the active pattern may have a stripe shape or a dot shape.

According to an exemplary embodiment of the present invention, a mask assembly is provided. The mask assembly includes a frame including an opening and a first mask having two end terminals supported by the frame. The first mask includes a mask main body, a plurality of active patterns, and a plurality of first dummy patterns. The mask main body has a band shape extended in the first direction. The plurality of active patterns is separately disposed in the first direction on the mask main body. The plurality of first dummy patterns is disposed between neighboring active patterns from among the plurality of active patterns. Each of the plurality of active patterns has a first shape and each of the plurality of first dummy patterns has a second shape.

In an embodiment, the mask assembly may further include a second mask having substantially the same configuration as the first mask. The first and second masks may be disposed in a second direction crossing the first direction in the opening of the frame.

According to an exemplary embodiment of the present invention, a mask having two end terminals supported by a frame is provided. The mask includes a mask main body, a plurality of active patterns and a first dummy pattern. The mask main body has a band shape extended in the first direction. The plurality of active patterns is separately disposed in the first direction on the mask main body. The first dummy pattern is disposed between an outermost active pattern in the first direction from among the plurality of active patterns and one end terminal of the mask main body. The first dummy pattern is different in shape from each of the plurality of active patterns.

In an embodiment, the mask may further include a plurality of second dummy patterns. The plurality of second dummy patterns may be disposed between neighboring active patterns of the plurality of active patterns. Each of the second dummy patterns may be different in shape from each of the plurality of active pattern and the first dummy pattern.

In an embodiment, the mask may further include a third dummy pattern. The third dummy pattern may be disposed between the outermost active pattern of the plurality of active patterns in the first direction and the first dummy pattern.

In an embodiment, the third dummy pattern may be different in shape from each of the plurality of second dummy patterns.

In an embodiment, the third dummy pattern may have substantially the same shape as each of the plurality of second dummy patterns.

### BRIEF DESCRIPTION OF THE DRAWINGS

A more complete appreciation of the present invention disclosure and many of the attendant aspects thereof will be readily obtained as the same becomes better understood by reference to the following detailed description when considered in connection with the accompanying drawings, wherein:

FIG. 1 is an exploded perspective view of a mask assembly according to an exemplary embodiment of the present invention;

FIG. 2 is a top plan view of a mask assembly according to an exemplary embodiment of the present invention;

FIG. 3 is a top plan view of a mask included in a mask assembly according to an exemplary embodiment of the present invention;

FIG. 4 is a top plan view of a mask according to an exemplary embodiment of the present invention;

FIG. 5 is a top plan view of a mask according to an exemplary embodiment of the present invention;

FIG. 6 is a top plan view of a mask according to an exemplary embodiment of the present invention; and

FIG. 7 is a top plan view of a mask according to an exemplary embodiment of the present invention.

### DETAILED DESCRIPTION OF THE INVENTION

The present invention will be described more fully hereinafter with reference to accompanying drawings, in which exemplary embodiments of the present invention are shown. However, the present invention may be embodied in various forms without departing from the spirit or scope of the present invention.

Accordingly, the drawings and description may be regarded as illustrative in nature and not restrictive. Like reference numerals may refer to like elements throughout the specification.

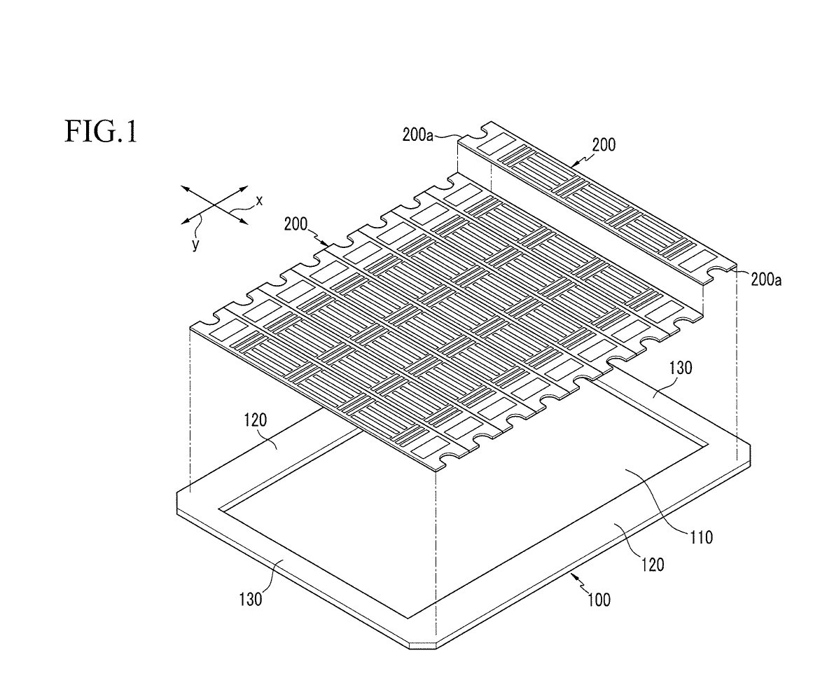

A mask assembly according to an exemplary embodiment of the present invention will now be described with reference to FIG. 1 to FIG. 3.

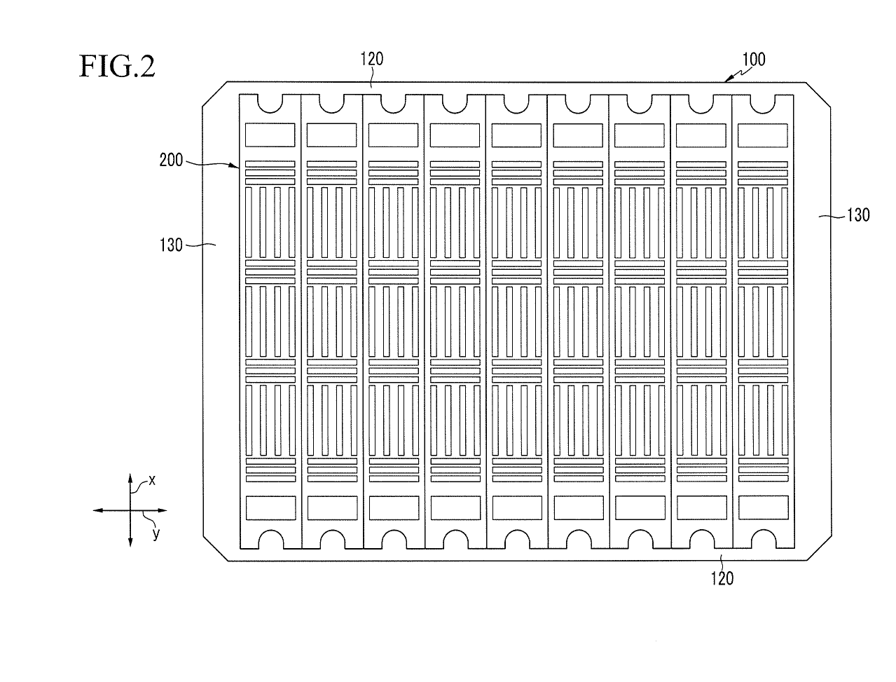

FIG. 1 is an exploded perspective view of a mask assembly according to an exemplary embodiment of the present invention. FIG. 2 is a top plan view of a mask assembly according to an exemplary embodiment of the present invention.

As shown in FIG. 1 and FIG. 2, the mask assembly includes a frame 100 and a plurality of masks 200.

The frame 100 includes an opening 110 that fixes and supports both ends 200a of each of the plurality of masks 200, and exposes the masks 200. The frame 100 further includes a pair of first supports 120 and a pair of second supports 130. The pair of first supports 120 face each other in a first direction (x) with an opening 110 therebetween and the pair of second supports 130 face each other in a second direction (y) with the opening 110 therebetween. Here, the second direction (y) crosses the first direction (x). Both ends 200a of each mask 200 are supported at the first supports 120. For example, both ends 200a of each mask 200 may be supported at the first supports 120 of the frame 100 by using a fixing method such as welding while a tensile force is applied in the first direction (x).

In the frame 100 of the mask assembly according to an exemplary embodiment of the present invention, the first supports 120 may form a long side of the frame 100 having a quadrangular shape and the second supports 130 may form a short side of the frame 100. However, in the frame of the mask assembly according to an exemplary embodiment of the present invention, the first supports and the second supports 130 may be formed to have substantially the same length.

Further, the frame of the mask assembly according to an embodiment of the present invention may be formed in a polygonal or circular shape.

The mask 200 fixed to the frame 100 is may be supported on the frame 100 while a tensile force is applied in the first direction (x), and the frame 100 may receive a compressive force in the first direction (x) (e.g., an elongation direction of the mask 200) by the tensile force in the first direction (x) applied to the mask 200. Thus, the frame 100 may be formed with a metal material such as stainless steel, or other metal having great rigidity to prevent the frame 100 from being deformed by the compressive force of the mask 200.

The mask 200 may have a band shape that extends in the first direction (x), and both ends 200a thereof may be supported by the frame 100 in the state where the tensile force is applied in the first direction (x). For example, multiple masks 200 may be formed on the mask 200, disposed in the second direction (y) crossing the first direction (x), and supported at the frame 100.

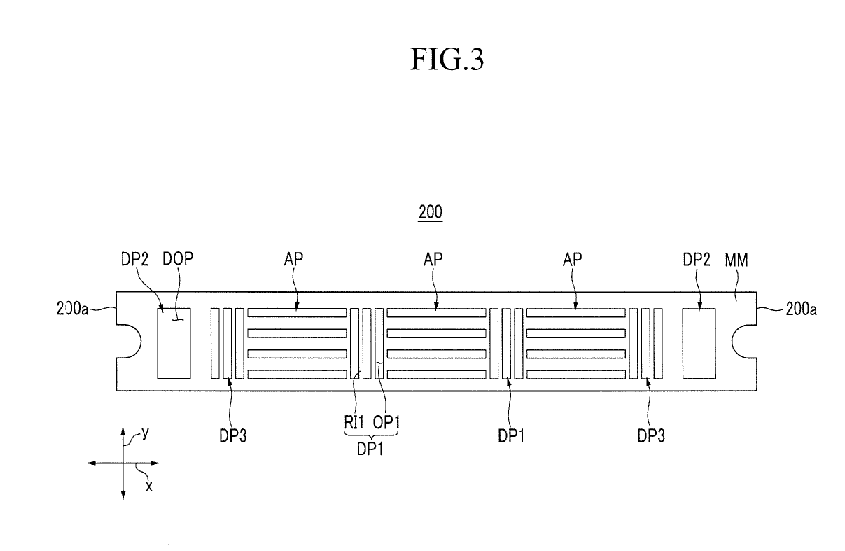

FIG. 3 is a top plan view of a mask included in a mask assembly according to an exemplary embodiment of the present invention.

As shown in FIG. 3, the mask 200 includes a mask main body (MM), an active pattern (AP), a first dummy pattern (DP1), a second dummy pattern (DP2), and a third dummy pattern (DP3).

The mask main body (MM) may be disposed in the opening 110 of the frame 100 and may be supported on the frame 100.

For example, multiple active patterns (AP) may be provided, separately disposed on the mask 200 in the first direction (x), and may be formed on the mask main body (MM). Each active pattern (AP) may correspond to an organic light emitting display. Thus, organic light emitting patterns that form the organic light emitting displays may be simultaneously formed on a mother substrate by a single process through the mask 200. Here, the organic light emitting display may be manufactured on the mother substrate.

For example, each active pattern (AP) may be disposed on the mask 200 to correspond to a deposition area of the organic light emitting patterns that configure an organic light emitting diode (OLED) display. Each active pattern (AP) has an opening that penetrates the mask 200 so that the organic light emitting patterns may be formed on the mother substrate through the opening of each active pattern (AP). Each active pattern (AP) may have a first shape that is a stripe-type open pattern.

The active pattern (AP) of the mask 200 included in the mask assembly according to an exemplary embodiment of the present invention may have a stripe shape, however a shape of the active pattern (AP) of the mask of the present invention is not limited thereto. For example, the shape may be a dot or polygonal shape.

For example, multiple first dummy patterns (DP1) may be provided and disposed between neighboring active patterns (AP).

Each first dummy pattern (DP1) has a second shape that is different from the first shape of the active pattern (AP). Each first dummy pattern (DP1) includes a first opening (OP1) and a first rib (RI1) that configures the second shape.

The first opening (OP1) extends in the second direction (y) crossing the first direction (x). For example, multiple first openings (OP1) may be provided and may be disposed in the first direction (x) to neighbor each other.

The first rib (RI1) surrounds each of the first openings (OP1) and forms the first openings (OP1) by having a comb-and-teeth shape.

For example, two second dummy patterns (DP2) may be provided. One second dummy pattern (DP2) may be disposed between one outermost active pattern (AP) in the first direction (x) from among the active patterns (AP) and one end 200a of the mask main body (MM). The other second dummy pattern (DP2) may be disposed between the other outermost active pattern (AP) in the first direction (x) from among the active patterns (AP) and the other end 200a of the mask main body (MM).

The second dummy pattern (DP2) has a third shape that is different from those of the active pattern (AP) and the first dummy pattern (DP1).

The second dummy pattern (DP2) includes a quadrangular dummy opening (DOP) and forms the third shape.

For example, two third dummy patterns (DP3) may be provided. One third dummy pattern (DP3) may be disposed between the one outermost active pattern (AP) in the first direction (x) from among the active patterns (AP) and the one second dummy pattern (DP2). The other third dummy pattern (DP3) may be disposed between the other outermost active pattern (AP) in the first direction (x) from among the active patterns (AP) and the other second dummy pattern (DP2).

The third dummy pattern (DP3) has substantially the same shape (e.g., second shape) as each of the first dummy patterns (DP1).

As described above, the mask 200 of the mask assembly according to an exemplary embodiment of the present invention includes the active pattern (AP), the first dummy pattern (DP1), the second dummy pattern (DP2), and the third dummy pattern (DP3). Accordingly, when a tensile force is applied to the mask 200 in the first direction (x), the second dummy pattern (DP2) may be deformed by the tensile force, and the third dummy pattern (DP3) and the first dummy pattern (DP1) may be sequentially deformed. As a result, the tensile force applied to the mask 200 may be distributed over the first dummy pattern (DP1), the second dummy pattern (DP2), and the third dummy pattern (DP3). Thus, deformation of the active pattern (AP) by the tensile force applied in the first direction (x) may be controlled to be lowered.

Accordingly, the mask 200 having reduced deformation in shape of the active pattern (AP) and a mask assembly including the same may be provided.

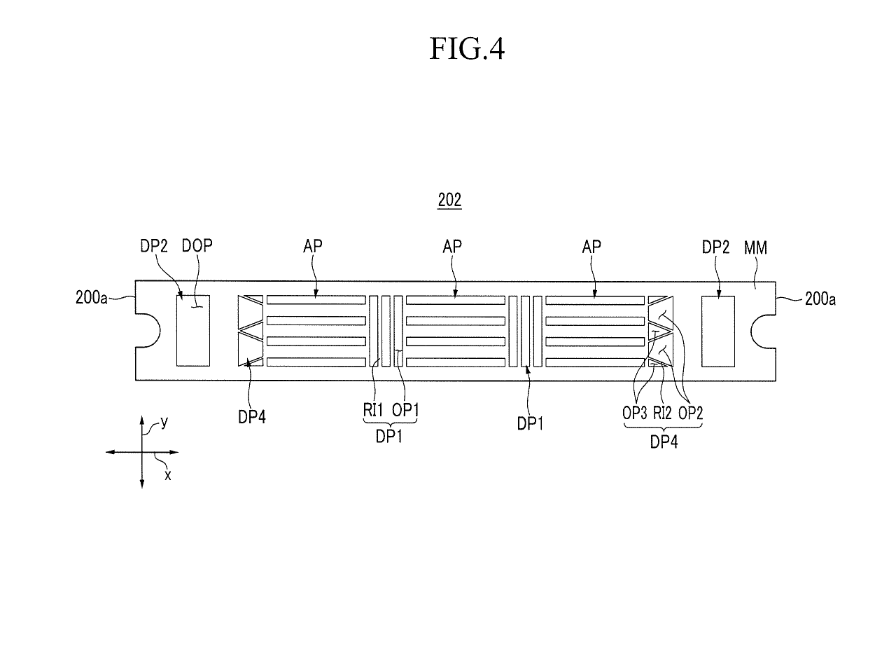

Referring to FIG. 4, a mask 202 according to an exemplary embodiment of the present invention will now be described.

Distinctive features that differ from the mask 200 according to the exemplary embodiment of the present invention illustrated in FIG. 3 will be described, and the omitted description may follow that of the mask 200 illustrated in FIG. 3. The mask 202 may have the same reference numerals for the same constituent elements as the mask 200 shown in FIG. 3.

FIG. 4 is a top plan view of a mask according to an exemplary embodiment of the present invention.

As shown in FIG. 4, the mask 202 includes the mask main body (MM), the active pattern (AP), the first dummy pattern (DP1), the second dummy pattern (DP2), and a fourth dummy pattern (DP4).

For example, two fourth dummy patterns (DP4) may be provided. One fourth dummy pattern (DP4) may be disposed between the one outermost active pattern (AP) in the first direction (x) hunt among the active patterns (AP) and the one second dummy pattern (DP2). The other fourth dummy pattern (DP4) may be disposed between the other outermost active pattern (AP) in the first direction (x) from among the active patterns (AP) and the other second dummy pattern (DP2).

The fourth dummy pattern (DP4) has a fourth shape that is different from the shapes of the active pattern (AP), the first dummy pattern (DP1), and the second dummy pattern (DP2).

The fourth dummy pattern (DP4) includes a second opening (OP2), a third opening (OP3), and a second rib (RI2) that configures the fourth shape.

For example, multiple second openings and third openings (OP3) may be provided. The second openings (OP2) and the third openings (OP3) may be alternatively disposed in the second direction (y) and thus, may form a quadrangular shape.

The second opening (OP2) may have a trapezoidal shape and the third opening (OP3) may have a triangular shape.

The second rib (RI2) surrounds each of the second openings (OP2) and the third openings (OP3), and forms the second openings (OP2) and the third openings (OP3).

As described above, the mask 202 according to an exemplary embodiment of the present invention includes the active pattern (AP), the first dummy pattern (DP1), the second dummy pattern (DP2), and the fourth dummy pattern (DP4). Accordingly, when a tensile force is applied to the mask 202 in the first direction (x), the second dummy pattern (DP2) may be deformed by the tensile force, and the fourth dummy pattern (DP4) and the first dummy pattern (DP1) may be sequentially deformed. As a result, the tensile force applied to the mask 202 may be distributed over the first dummy pattern (DP1), the second dummy pattern (DP2), and the fourth dummy pattern (DP4). Thus, deformation of the active pattern (AP) by the tensile force applied in the first direction (x) may be controlled to be lowered.

Accordingly, the mask 202 having reduced deformation in shape of the active pattern (AP) and a mask assembly including the same may be provided.

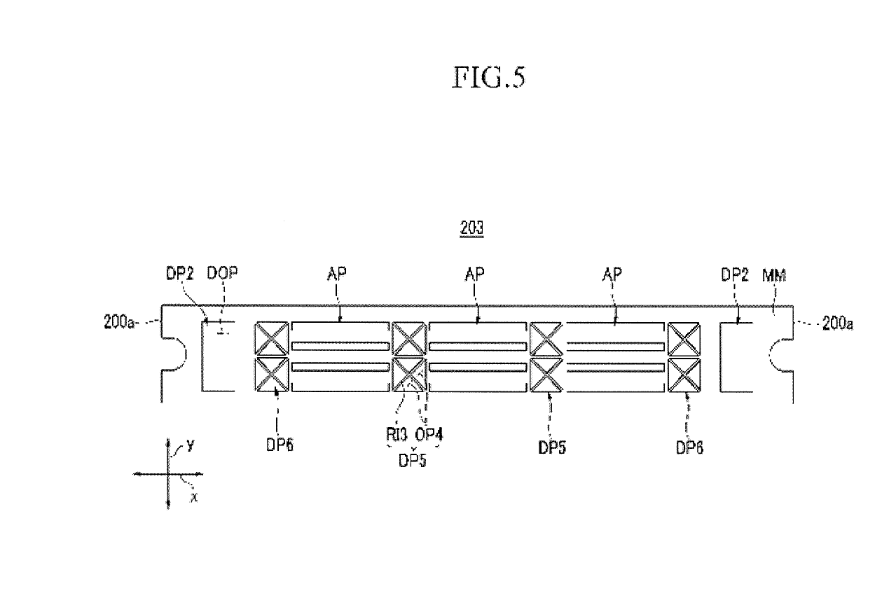

Referring to FIG. 5, a mask 203 according to an exemplary embodiment of the present invention will now be described.

Distinctive features that differ from the mask 200 according to an exemplary embodiment of the present invention illustrated in FIG. 3 will be described, and the omitted description may follow that of the mask 200 as illustrated in FIG. 3. The mask 203 as illustrated in FIG. 5 may have the same reference numerals for the same constituent elements as the mask 200 as illustrated in FIG. 3.

FIG. 5 is a top plan view of a mask according to an exemplary embodiment of the present invention.

As shown in FIG. 5, the mask 203 includes the mask main body (MM), the active pattern (AP), a fifth dummy pattern (DP5), the second dummy pattern (DP2), and a sixth dummy pattern (DP6).

For example, multiple fifth dummy patterns (DP5) may be provided and disposed between the neighboring active patterns (AP).

The fifth dummy pattern (DP5) and the sixth dummy pattern (DP6) may have a fifth shape that is different from the shapes of the active pattern (AP) and the second dummy pattern (DP2). The fifth dummy pattern (DP5) includes a fourth opening (OP4) and a third rib (RI3) that configures the fifth shape.

For example, multiple fourth openings (OP4) may be provided. Each of the multiple fourth openings (OP4) may have a triangular shape. The fourth openings (OP4) are disposed to neighbor each other and form a quadrangular shape.

For example, eight fourth openings (OP4) may be provided in the fifth dummy pattern (DP5). Four fourth openings (OP4) of the eight fourth openings (OP4) may form a first quadrangular shape, the other four fourth openings (OP4) of the eight fourth openings (OP4) may form a second quadrangular shape, and accordingly, the eight fourth openings (OP4) may form a quadrangular shape including the first and second quadrangular shapes.

The third rib (RI3) surrounds each of the fourth openings (OP4) and forms the fourth openings (OP4).

For example, two sixth dummy patterns (DP6) may be provided. One sixth dummy pattern (DP6) may be disposed between the one outermost active pattern (AP) in the first direction (x) from among the active patterns (AP) and the one second dummy pattern (DP2). The other sixth dummy pattern (DP6) may be disposed between the other outermost active pattern (AP) in the first direction (x) from among the active patterns (AP) and the other second dummy pattern (DP2).

Each sixth dummy pattern (DP6) has the same shape as the fifth dummy pattern (DP5).

As described above, the mask 203 according to an exemplary embodiment of the present invention includes the active pattern (AP), the fifth dummy pattern (DP5), the second dummy pattern (DP2), and the sixth dummy pattern (DP6). Accordingly, when the tensile force is applied to the mask 203 in the first direction (x), the second dummy pattern (DP2) may be deformed by the tensile force, the sixth dummy pattern (DP6) and the fifth dummy pattern (DP5) may be sequentially deformed. As a result, the tensile force applied to the active pattern (AP) may be distributed over the fifth dummy pattern (DP5), the second dummy pattern (DP2), and the sixth dummy pattern (DP6). Thus, deformation of the active pattern (AP) by the tensile force applied in the first direction (x) may be controlled to be lowered.

Accordingly, the mask 203 having reduced deformation in shape of the active pattern (AP) and a mask assembly including the same may be provided.

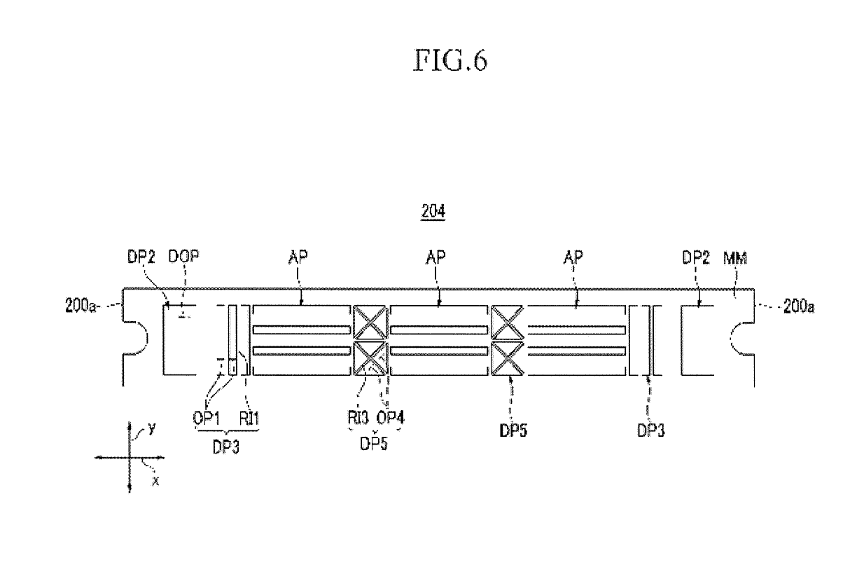

Referring to FIG. 6, a mask 204 according to an exemplary embodiment of the present invention will now be described.

Distinctive features that differ from the mask 203 as illustrated in FIG. 5 will be described, and the omitted description may follow that of the mask 203 as illustrated in FIG. 5. The mask 204 may have the same reference numerals for the same constituent elements as the mask 203 as illustrated in FIG. 5.

FIG. 6 is a top plan view of a mask according to an exemplary embodiment of the present invention.

As shown in FIG. 6, the mask 204 includes the mask main body (MM), the active pattern (AP), the fifth dummy pattern (DP5), the second dummy pattern (DP2), and the third dummy pattern (DP3).

For example, two third dummy patterns (DP3) may be provided. One third dummy pattern (DP3) may be disposed between the one outermost active pattern (AP) in the first direction (x) from among a plurality of active patterns (AP) and the one second dummy pattern (DP2). The other third dummy pattern (DP3) may be disposed between the other outermost active pattern (AP) in the first direction (x) from among the active patterns (AP) and the other second dummy pattern (DP2).

Each third dummy pattern (DP3) has the second shape that is different from the shapes of the active pattern (AP), the fifth dummy pattern (DP5), and the second dummy pattern (DP2).

The third dummy pattern (DP3) includes a first opening (OP1) and a first rib (RI1) that configures the second shape.

The first opening (OP1) is extended in the second direction (y) crossing the first direction (x).

For example, multiple first openings (OP1) may be provided and may be disposed to neighbor each other in the first direction (x).

The first rib (RI1) surrounds each of the first openings (ON) and forms the first opening (OP1).

As described above, the mask 204 according to an exemplary embodiment of the present invention includes the active pattern (AP), the fifth dummy pattern (DP5), the second dummy pattern (DP2), and the third dummy pattern (DP3). Accordingly, when the tensile force is applied to the mask 204 in the first direction (x), the second dummy pattern (DP2) may be deformed by the tensile force, the third dummy pattern (DP3) and the fifth dummy pattern (DP5) may be sequentially deformed. As a result, the tensile force applied to the active pattern (AP) may be distributed over the fifth dummy pattern (DP5), the second dummy pattern (DP2), and the third dummy pattern (DP3). Thus, deformation of the active pattern (AP) by the tensile force applied in the first direction (x) may be controlled to be lowered.

Accordingly, the mask 204 having reduced deformation in shape of the active pattern (AP) and a mask assembly including the same may be provided.

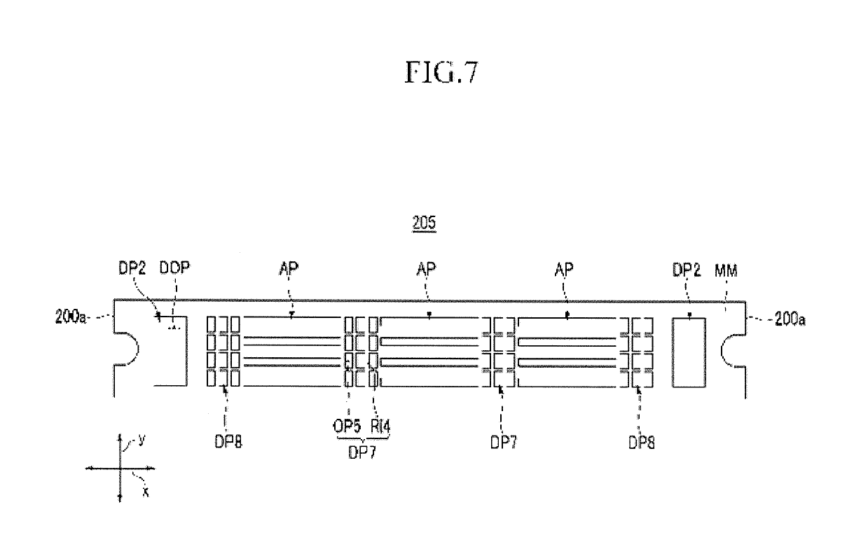

Referring to FIG. 7, a mask 205 according to an exemplary embodiment of the present invention will now be described.

Distinctive features that differ from the mask 200 as illustrated in FIG. 3 will be described, and the omitted description may follow that of the mask 200 as illustrated in FIG. 3. The mask 205 may have the same reference numerals for the same constituent elements as the mask 200 as illustrated in FIG. 3.

FIG. 7 is a top plan view of a mask according to an exemplary embodiment of the present invention.

As shown in FIG. 7, the mask 205 includes the mask main body (MM), the active pattern (AP), a seventh dummy pattern (DP7), the second dummy pattern (DP2), and an eighth dummy pattern (DP8).

For example, multiple seventh dummy patterns (DP7) may be provided and disposed between the neighboring active patterns (AP).

The seventh dummy pattern (DP7) has a sixth shape that is different from the first shape of the active pattern (AP). The seventh dummy pattern (DP7) includes a fifth opening (OP5) and a fourth rib (RI4) that configures the sixth shape.

For example, multiple fifth openings (OP5) may be provided. Each of the multiple fifth openings (OP5) has a quadrangular shape. The fifth openings (OP5) may be disposed in a matrix form in the first direction (x) and the second direction (y).

The fourth rib (RI4) surrounds each of the fifth openings (OP5) and forms the fifth openings (OP5).

For example, two eighth dummy patterns (DP8) may be provided. One eighth dummy pattern (DP8) may be disposed between the one outermost active pattern (AP) in the first direction (x) from among a plurality of the active patterns (AP) and the one second dummy pattern (DP2). The other eighth dummy pattern (DP8) may be disposed between the other outermost active pattern (AP) in the first direction (x) from among the active patterns (AP) and the other second dummy pattern (DP2).

Each eighth dummy pattern (DP8) has the same shape as the seventh dummy pattern (DP7).

As described above, the mask 205 according to an exemplary embodiment of the present invention includes the active pattern (AP), the seventh dummy pattern (DP7), the second dummy pattern (DP2), and the eighth dummy pattern (DP8). Accordingly, when the tensile force is applied to the mask 205 in the first direction (x), the second dummy pattern (DP2) may be deformed by the tensile force, the eighth dummy pattern (DP8) and the seventh dummy pattern (DP7) may be sequentially deformed. As a result, the tensile force applied to the active pattern (AP) may be distributed over the seventh dummy pattern (DP7), the second dummy pattern (DP2), and the eighth dummy pattern (DP8). Thus, deformation of the active pattern (AP) by the tensile force applied in the first direction (x) may be lowered.

Accordingly, the mask 205 having reduced deformation in shape of the active pattern (AP) and a mask assembly including the same may be provided.

While exemplary embodiments of the present invention has been described in connection with what is presently considered to be practical exemplary embodiments, it is to be understood that the invention is not limited to the disclosed embodiments, but, is intended to cover various modifications and equivalent arrangements included within the spirit and scope of the disclosure of the application.

What is claimed is:

1. A mask having two end terminals comprising:
a mask main body having a band shape extended in a first direction;
a plurality of active patterns separately disposed in the first direction on the mask main body; and
a plurality of first dummy patterns disposed between neighboring active patterns of the plurality of active patterns,
wherein each of the plurality of active patterns has a first shape,
wherein each of the plurality of first dummy patterns has a second shape.

2. The mask of claim 1, further including
a second dummy pattern disposed between an outermost active pattern in the first direction from among the plurality of active patterns and one end terminal of the mask main body, wherein the second dummy pattern has a third shape.

3. The mask of claim 2, wherein
the second dummy pattern includes a quadrangular dummy opening.

4. The mask of claim 2, further including
a third dummy pattern disposed between the outermost active pattern of the plurality of active patterns in the first direction and the second dummy pattern, wherein the third dummy pattern has the second shape.

5. The mask of claim 2, wherein
each of the plurality of first dummy pattern includes:
a plurality of first openings extended in a second direction crossing the first direction and disposed to neighbor each other in the first direction; and
a first rib surrounding each of the plurality of first openings.

6. The mask of claim 5, further including
a fourth dummy pattern disposed between the outermost active pattern in the first direction from among the plurality of active patterns and the second dummy pattern, wherein the fourth dummy pattern has a fourth shape.

7. The mask of claim 6, wherein
the fourth dummy pattern includes:
a plurality of trapezoidal second openings alternately disposed in the second direction;
a plurality of triangular third openings; and
a second rib surrounding each of the trapezoidal second openings and the triangular third openings.

8. The mask of claim 2, wherein
each of the plurality of first dummy patterns includes:
a plurality of triangular fourth openings disposed to neighbor each other and form a quadrangular shape; and
a third rib surrounding each of the plurality of triangular fourth openings.

9. The mask of claim 8, further including
a fifth dummy pattern disposed between the outermost active pattern in the first direction from among the active patterns and the second dummy pattern, wherein the fifth dummy pattern has a fifth shape.

10. The mask of claim 9, wherein
the fifth dummy pattern includes:
a plurality of fifth openings extended in a second direction crossing the first direction and disposed to neighbor each other in the first direction; and
a fourth rib surrounding each of the plurality of fifth openings.

11. The mask of claim 2, wherein
each of the plurality of first dummy patterns includes:
a plurality of sixth openings disposed in a matrix form in the first direction and a second direction crossing the first direction; and
a fifth rib surrounding each of the plurality of sixth openings.

12. The mask of claim 1, wherein
the first shape is a stripe shape or a dot shape.

13. A mask assembly comprising:
a frame including an opening; and
a first mask having two end terminals supported by the frame, wherein the first mask comprises:
a mask main body having a band shape extended in a first direction;
a plurality of active patterns separately disposed in the first direction on the mask main body; and
a plurality of first dummy patterns disposed between neighboring active patterns of the plurality of active patterns,
wherein each of the plurality of active patterns has a first shape,
wherein each of the plurality of first dummy patterns has a second shape.

14. The mask assembly of claim 13, further comprises
a second mask having substantially the same configuration as the first mask,
wherein the first and second masks are disposed in a second direction crossing the first direction in the opening of the frame.

15. A mask having two end terminals:
a mask main body having a band shape extended in a first direction;
a plurality of active patterns separately disposed in the first direction on the mask main body; and
a first dummy pattern disposed between an outermost active pattern in the first direction from among the plurality of active patterns and one end terminal of the mask main body,
wherein the first dummy pattern is different in shape from each of the plurality of active patterns.

16. The mask of claim 15, further including
a plurality of second dummy patterns disposed between neighboring active patterns of the plurality of active patterns, wherein each of the second dummy patterns is different in shape from each of the plurality of active patterns and the first dummy pattern.

17. The mask of claim 15, further including
a third dummy pattern disposed between the outermost active pattern of the plurality of active patterns in the first direction and the first dummy pattern.

18. The mask of claim 17, wherein
the third dummy pattern is different in shape from each of the plurality of second dummy patterns.

19. The mask of claim 17, wherein
the third dummy pattern has substantially the same shape as each of the plurality of second dummy patterns.
